(19) United States
(12) Patent Application Publication
(10) Pub. No.: US 2024/0202658 A1
(43) Pub. Date: Jun. 20, 2024

(54) ENTERPRISE EQUIPMENT RISK MANAGEMENT SYSTEM AND METHOD

(71) Applicants: Shannon L Tetreault, Glastonbury, CT (US); Peter Beaupre, Unionville, CT (US)

(72) Inventors: Shannon L Tetreault, Glastonbury, CT (US); Peter Beaupre, Unionville, CT (US)

(21) Appl. No.: 18/186,650

(22) Filed: Mar. 20, 2023

Related U.S. Application Data
(60) Provisional application No. 63/387,618, filed on Dec. 15, 2022.

(51) Int. Cl. G06Q 10/087; G06Q 10/20

(52) U.S. Cl. CPC G06Q 10/087; G06Q 10/20

(57) ABSTRACT

An enterprise data store may contain electronic records associated with enterprises (e.g., small businesses). For each enterprise, a set of electronic records may include an enterprise identifier, enterprise communication link data, and parameters associated with that enterprise (name, address, etc.). An enterprise equipment data store may contain electronic records associated with the plurality of enterprises. For each enterprise, a set of electronic records may include an enterprise identifier, enterprise equipment identifiers, and equipment parameters associated with each enterprise equipment identifier. A back-end application computer server may access the data stores to determine a selected enterprise identifier (and parameters associated with the selected enterprise identifier) and enterprise equipment parameters for the selected enterprise identifier. Based on the determined enterprise equipment parameters, the server may automatically generate at least one electronic message for the selected enterprise and transmit the electronic message in accordance with the enterprise communication link data.

### CROSS-REFERENCE TO RELATED APPLICATIONS

The present application claims the benefit of U.S. Patent Application No. 63/387,618 entitled “ENTERPRISE EQUIPMENT RISK MANAGEMENT SYSTEM AND METHOD” and filed on Dec. 15, 2022. The entire content of that application is incorporated herein by reference.

### TECHNICAL FIELD

The present application generally relates to computer systems and more particularly to computer systems that are adapted to accurately and/or automatically communicate with enterprises.

### BACKGROUND

An enterprise may utilize equipment connected with its day-to-day operations. For example, a small business owner might have a restaurant that uses a gas stove and hood, a refrigerator, a fryer, etc. to prepare food. Different types of equipment may be associated with different cleaning schedules, maintenance procedures, etc. (which can vary depending on the manufacturer or model of the equipment being used). Manually keeping track of these tasks can be time consuming and error prone task—especially when a substantial amount of equipment is being used.

It would be desirable to provide improved systems and methods to accurately and/or automatically provide an enterprise communication system. Moreover, the results should be easy to access, understand, interpret, update, etc.

### SUMMARY OF THE INVENTION

According to some embodiments, systems, methods, apparatus, computer program code and means are provided to accurately and/or automatically provide an enterprise communication system in a way that provides fast and useful results and that allows for flexibility and effectiveness when responding to those results.

Some embodiments are directed to an enterprise communication system implemented via a back-end application computer server. An enterprise data store may contain electronic records associated with enterprises (e.g., small businesses). For each enterprise, a set of electronic records may include an enterprise identifier, enterprise communication link data, and parameters associated with that enterprise (name, address, etc.). An enterprise equipment data store may contain electronic records associated with the plurality of enterprises. For each enterprise, a set of electronic records may include an enterprise identifier, enterprise equipment identifiers, and equipment parameters associated with each enterprise equipment identifier. A back-end application computer server may access the data stores to determine a selected enterprise identifier (and parameters associated with the selected enterprise identifier) and enterprise equipment parameters for the selected enterprise identifier. Based on the determined enterprise equipment parameters, the server may automatically generate at least one electronic message for the selected enterprise and transmit the electronic message in accordance with the enterprise communication link data.

Some embodiments comprise: means for accessing, by a back-end application computer server, an enterprise data store to determine a selected enterprise identifier and parameters associated with the selected enterprise identifier, wherein the enterprise data store contains electronic records associated with a plurality of enterprises, and, for each enterprise, a set of electronic records including an enterprise identifier, enterprise communication link data, and parameters associated with that enterprise; means for accessing an enterprise equipment data store to determine enterprise equipment parameters associated with the selected enterprise identifier, wherein the enterprise equipment data store contains electronic records associated with the plurality of enterprises, and, for each enterprise, a set of electronic records including an enterprise identifier, a set of enterprise equipment identifiers, and equipment parameters associated with each enterprise equipment identifier; based on the determined enterprise equipment parameters, means for automatically generating at least one electronic message for the selected enterprise; and means for automatically transmitting the electronic message in accordance with the enterprise communication link data.

In some embodiments, a communication device associated with a back-end application computer server exchanges information with remote devices in connection with interactive graphical user interfaces. The information may be exchanged, for example, via public and/or proprietary communication networks.

A technical effect of some embodiments of the invention is an improved and computerized way to communicate with enterprises in a way that provides fast and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 illustrates various parties that may be associated with some embodiments.

FIG. 2 is a high-level block diagram of an enterprise communication system in accordance with some embodiments.

FIG. 3 illustrates an enterprise communication method according to some embodiments.

FIG. 4 is an introductory smartphone display in accordance with some embodiments.

FIG. 5 is an enterprise information entry display according to some embodiments.

FIG. 6 is an inventory creation display for a stove in accordance with some embodiments.

FIG. 7 is an inventory creation display for a fryer according to some embodiments.

FIG. 8 is an inventory display in accordance with some embodiments.

FIG. 9 is a maintenance information display according to some embodiments.

FIG. 10 is a tutorial display in accordance with some embodiments.

FIG. 11 is a pop-up cross-sell notification display according to some embodiments.

FIG. 12 is a web browser warranty information display in accordance with some embodiments.

FIG. 13 is a service provider display according to some embodiments.

FIG. 14 is an insurance information display in accordance with some embodiments.

FIG. 15 is a claim submission display according to some embodiments.

FIG. 16 is an ESG information display in accordance with some embodiments.

FIG. 17 is an office inventory display in accordance with some embodiments.

FIG. 18 is a construction inventory display according to some embodiments.

FIG. 19 is backhoe warranty display in accordance with some embodiments.

FIG. 20 is a backhoe financing display according to some embodiments.

FIG. 21 is dental inventory display in accordance with some embodiments.

FIG. 22 is a block diagram of an apparatus in accordance with some embodiments.

FIG. 23 is a portion of a tabular enterprise data store according to some embodiments.

FIG. 24 is a portion of a tabular enterprise equipment data store according to some embodiments.

FIG. 25 is an operator or administrator display in accordance with some embodiments.

FIG. 26 illustrates a tablet computer with an enterprise information display according to some embodiments.

FIG. 27 illustrates a system having a predictive model in accordance with some embodiments.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data processing associated with enterprise communication. The present invention is directed to more than merely a computer implementation of a routine or conventional activity previously known in the industry as it provides a specific advancement in the area of electronic record analysis by providing improvements in the operation of a computer system that customizes enterprise communications (including those associated with risk relationships). The present invention provides improvement beyond a mere generic computer implementation as it involves the novel ordered combination of system elements and processes to provide improvements in the speed and accuracy of such a communication customization tool. Some embodiments of the present invention are directed to a system adapted to automatically customize enterprise communications, aggregate user data from multiple sources, automatically optimize enterprise operations to reduce unnecessary messages or communications, etc. Moreover, communication links and messages may be automatically established, aggregated, formatted, modified, removed, exchanged, etc. to improve network performance (e.g., by reducing an amount of network messaging bandwidth and/or storage required to create enterprise communication messages and/or to collect enterprise data).

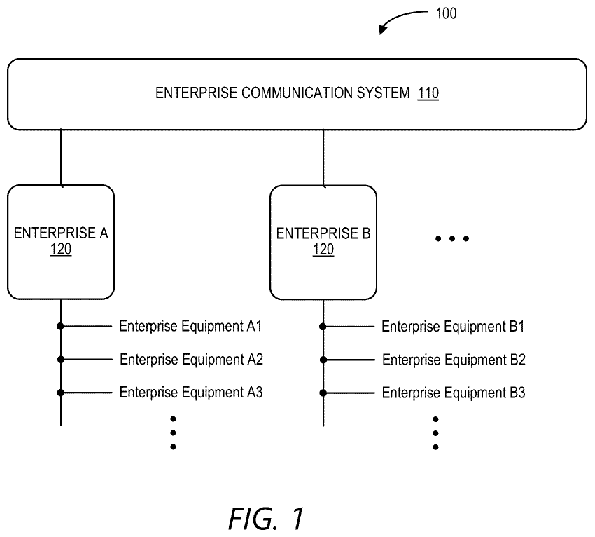

FIG. 1 illustrates 100 various parties that may be associated with some embodiments. An enterprise communication system 110 (e.g., associated with a back-end application computer server) may communicate with a number of different enterprises 120 (e.g., enterprise A, enterprise B, etc.). As used herein, the term “enterprise” may refer to any business such as a restaurant, a retailer, a manufacturer, a construction company, a medical service provider, etc. Each enterprise 120 may be associated with a set of enterprise equipment that it uses in day-to-day operations (e.g., equipment A1, A2, A3, etc.). As used herein, the term “equipment” may refer to, for example, an apparatus or machine that processes (e.g., by storing, moving, consuming, etc.) or transforms (e.g., by cooking, assembling, mixing, etc.) items during operation of a business.

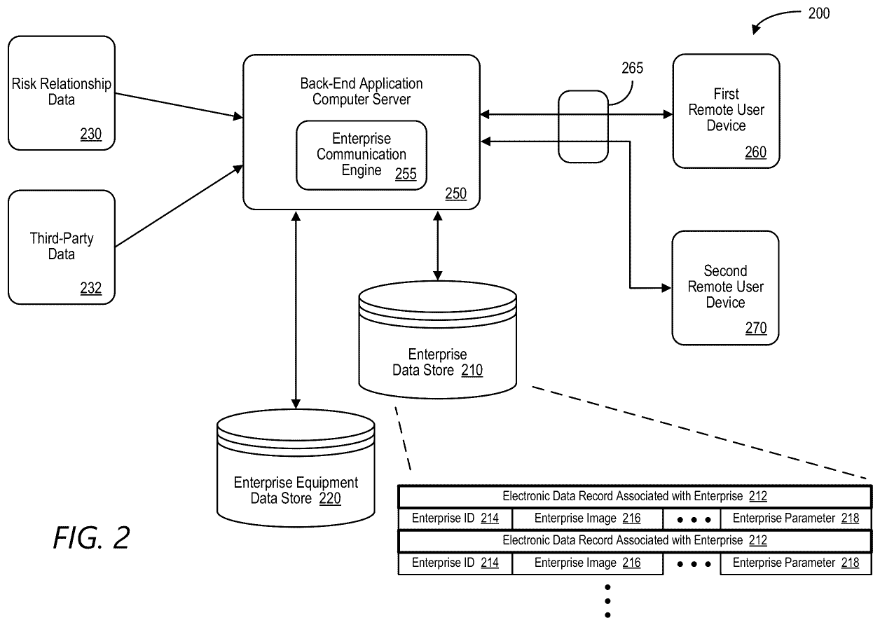

FIG. 2 is a high-level block diagram of an enterprise communication system 200 that may be used to interact with such enterprises 120 according to some embodiments of the present invention. In particular, the system 200 includes a back-end application computer server 250 that may access information in an enterprise data store 210 (e.g., storing a set of electronic records associated with enterprises 212, each record including, for example, one or more enterprise identifiers 214, enterprise images 216, enterprise parameters 218, etc.). The back-end application computer server 250 may also store information into other data stores, such as an enterprise equipment data store 220 and utilize an enterprise communication engine 255 to exchange messages (e.g., daily/weekly messages or instant notifications) and view, analyze, and/or update the electronic records. The back-end application computer server 250 may also exchange information with a first remote user device 260 and a second remote user device 270 (e.g., via a firewall 265). According to some embodiments, an interactive graphical user interface platform of the back-end application computer server 250 (and, in some cases, risk relationship data 230 and/or third-party data 232) may facilitate risk forecasts, recommendations, alerts, and/or the display of results via one or more remote administrator computers (e.g., to summarize system 200 performance) and/or the remote user devices 260, 270. For example, the first remote user device 260 may transmit annotated and/or updated information to the back-end application computer server 250. Based on the updated information, the back-end application computer server 250 may adjust data in the enterprise data store 210 and/or the enterprise equipment data store 220 and the change may (or may not) be used in connection with the second remote user device 270 (e.g., depending on whether the two users are associated with the same enterprise). Note that the back-end application computer server 250 and/or any of the other devices and methods described herein might be associated with a third party, such as a vendor that performs a service for an enterprise.

The back-end application computer server 250 and/or the other elements of the system 200 might be, for example, associated with a Personal Computer (“PC”), laptop computer, smartphone, an enterprise server, a server farm, and/or a database or similar storage devices. According to some embodiments, an “automated” back-end application computer server 250 (and/or other elements of the system 200) may facilitate the automated access and/or update of electronic records in the data stores 210, 220 and/or the creation of communication messages. As used herein, the term “automated” may refer to, for example, actions that can be performed with little (or no) intervention by a human.

As used herein, devices, including those associated with the back-end application computer server 250 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 250 may store information into and/or retrieve information from the enterprise data store 210 and/or the enterprise equipment data store 220. The data stores 210, 220 may be locally stored or reside remote from the back-end application computer server 250. As will be described further below, the enterprise data store 210 may be used by the back-end application computer server 250 in connection with an interactive user interface to access and update electronic records. Although a single back-end application computer server 250 is shown in FIG. 2, any number of such devices may be included. Moreover, various devices described herein might be combined according to embodiments of the present invention. For example, in some embodiments, the back-end application computer server 250 and enterprise data store 210 might be co-located and/or may comprise a single apparatus.

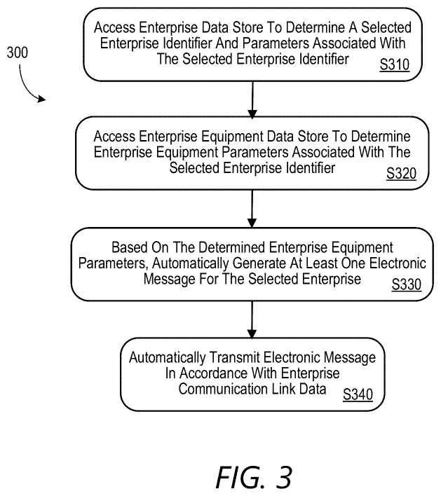

Note that the system 200 of FIG. 2 is provided only as an example, and embodiments may be associated with additional elements or components. According to some embodiments, the elements of the system 200 automatically transmit information associated with an interactive user interface display over a distributed communication network. FIG. 3 illustrates a method 300 that might be performed by some or all of the elements of the system 200 described with respect to FIG. 2, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, a back-end application computer server may access an enterprise data store to determine a selected enterprise identifier and parameters associated with a selected enterprise identifier. The enterprise data store may, for example, contain electronic records associated with a plurality of enterprises (e.g., small businesses), and, for each enterprise, a set of electronic records including an enterprise identifier, enterprise communication link data, and parameters associated with that enterprise. The parameters associated with the enterprise might include, according to some embodiments, an enterprise name, an enterprise address, an enterprise date (e.g., the date a business opened, a risk relationship identifier (e.g., an insurance policy identifier, etc. The enterprise communication link data may comprise any information that lets the enterprise communication system transmit messages to enterprise devices, such as a communication address, a telephone number, an email address, a username and password, etc.

At S320, the system may access an enterprise equipment data store to determine enterprise equipment parameters associated with the selected enterprise identifier. The enterprise equipment data store may, for example, contain electronic records associated with the plurality of enterprises, and, for each enterprise, a set of electronic records including an enterprise identifier, a set of enterprise equipment identifiers, and equipment parameters associated with each enterprise equipment identifier. According to some embodiments, the parameters associated with the enterprise include an enterprise type (e.g., a florist, a coffee shop, etc.) and the collection of information about the enterprise equipment is based at least in part on the enterprise type. The enterprise equipment parameters might include, for example, an equipment type, a manufacturer, a model number, a date of manufacture or purchase, Internet of Things (“IoT”) information (e.g., to collect information from a refrigerator via WiFi, an IP address, or URL), etc. According to some embodiments, the system may further facilitate a registration and/or activation of smart IoT devices (e.g., by automatically contacting a manufacturer when a new piece of equipment is initially powered up).

Based on the determined enterprise equipment parameters, the system may automatically generate at least one electronic message for the selected enterprise at S330. The electronic message might be associated with, for example, equipment maintenance information, a tutorial or product manual, or cross-sell information (e.g., offer of a product or service). According to some embodiments electronic message is associated with a push notification (e.g., via an application or smartphone operating system). At S340, the system may automatically transmit the electronic message in accordance with the enterprise communication link data. According to some embodiments, the back-end application computer server calculates an enterprise risk score based at least in part on the enterprise equipment parameters associated with the selected enterprise identifier. For example, the back-end application computer server may be associated with an insurer and the risk score may determine an insurance premium, an insurance claim workflow, etc.

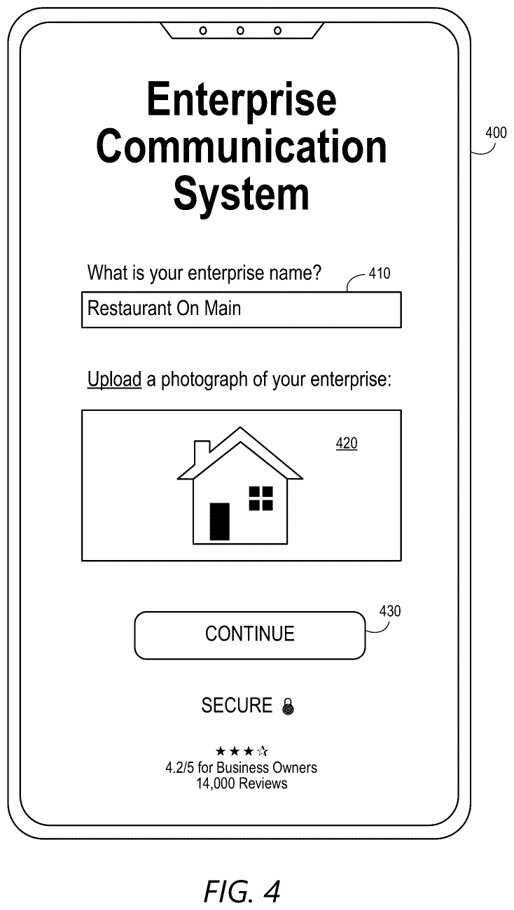

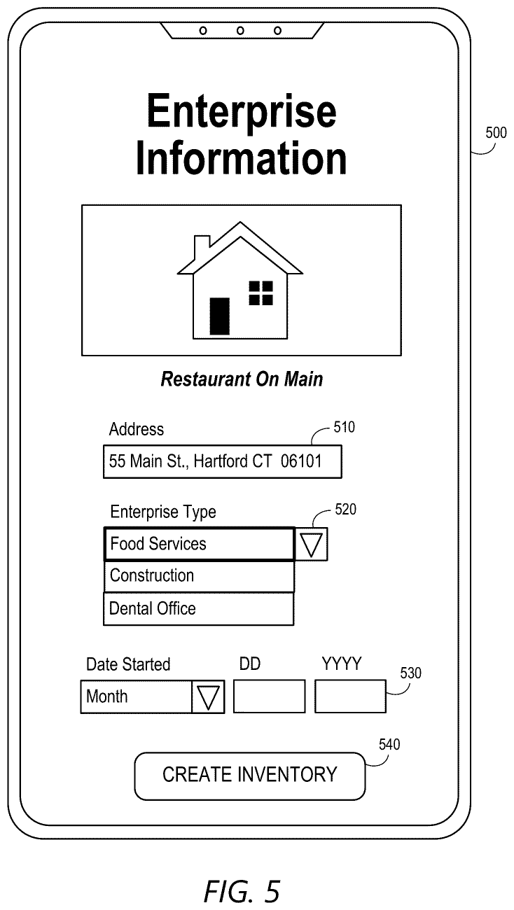

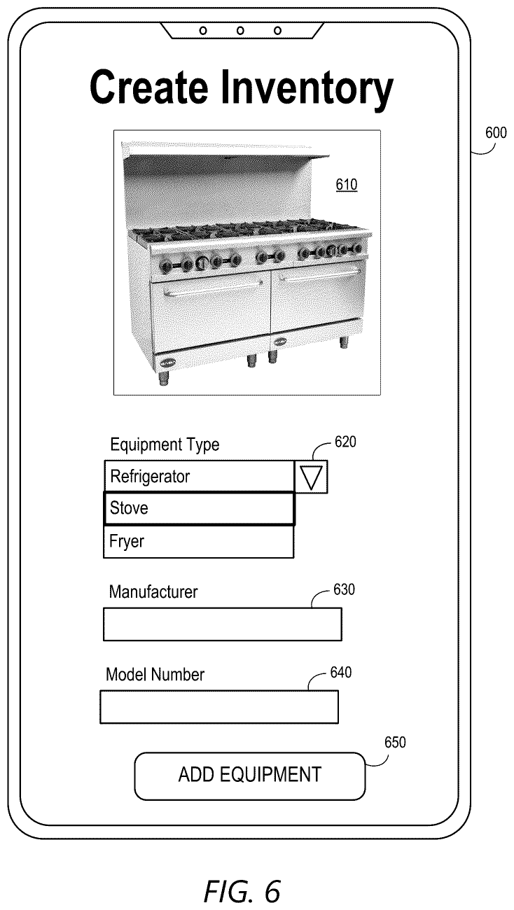

FIG. 4 is an introductory smartphone application display 400 in accordance with some embodiments. The display 400 collects an enterprise name or identifier 410 and can be used to upload a picture 420 (e.g., a business storefront). Selection of a “Continue” icon 430 may result in an enterprise information entry display 500 (shown in FIG. 5) that can be used to collect an enterprise address 510, an enterprise type or category 520, an enterprise date 530 (e.g., a date on which a business opened), etc. After the enterprise information is collected, selection of a “Create Inventory” icon 540 may result in an inventory creation display 600 as shown in FIG. 6. Note that in some cases, information other than an enterprise address 510 might be appropriate for a business (e.g., the owner of a food truck might instead provide a license plate number).

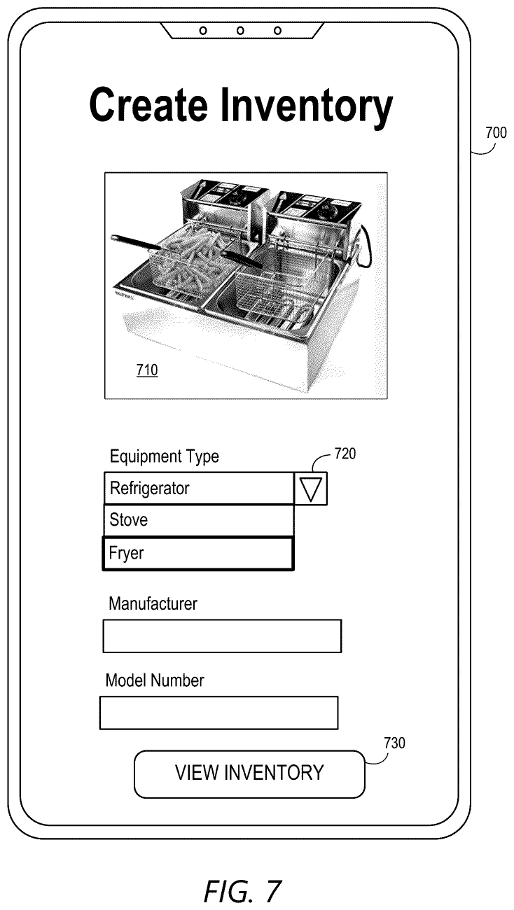

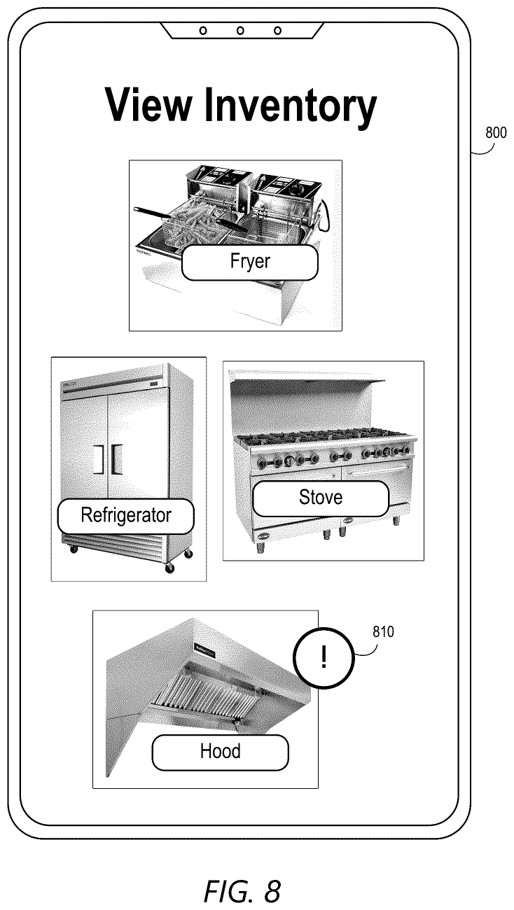

In particular, the display 600 is adding a stove to a restaurant's inventory of equipment. The display 600 may collect an image 610 of the equipment, an equipment type or category 620, an equipment manufacturer 630, model number 640. Selection of an “Add Equipment” icon 650 may let the enterprise add additional items, such the inventory creation display 700 of FIG. 7 for a fryer (including a fryer image 710 and type 720) according to some embodiments. When all of the equipment has been uploaded, selection of a “View Inventory” display 730 may result in an inventory display 800 such as one illustrated in FIG. 8. The display 800 shows the equipment associated with the restaurant (e.g., a fryer, refrigerator, stove, and hood). According to some embodiments, the display may include an alert 810 or warning (e.g., as illustrated by the “!” icon in FIG. 8). Other examples of equipment (depending on the type of business) might include delivery vehicles, Point Of Sale (“POS”) devices, x-ray machines, etc.

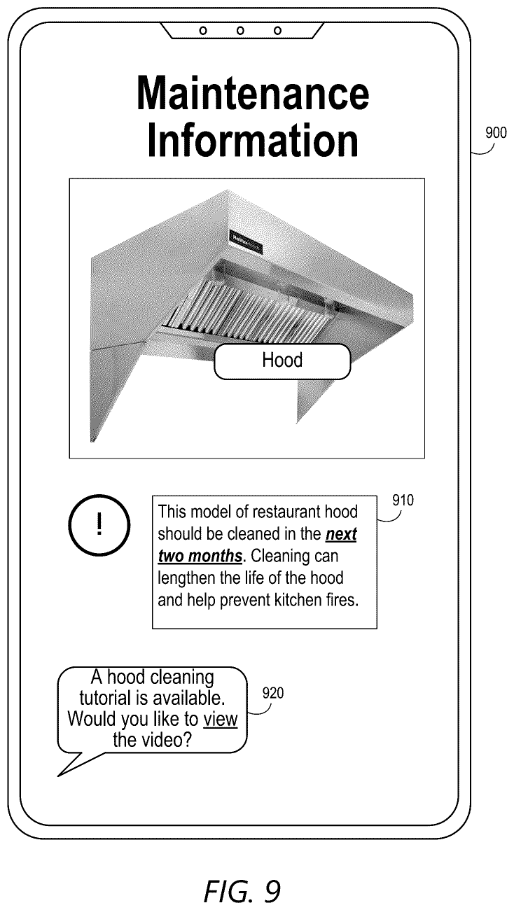

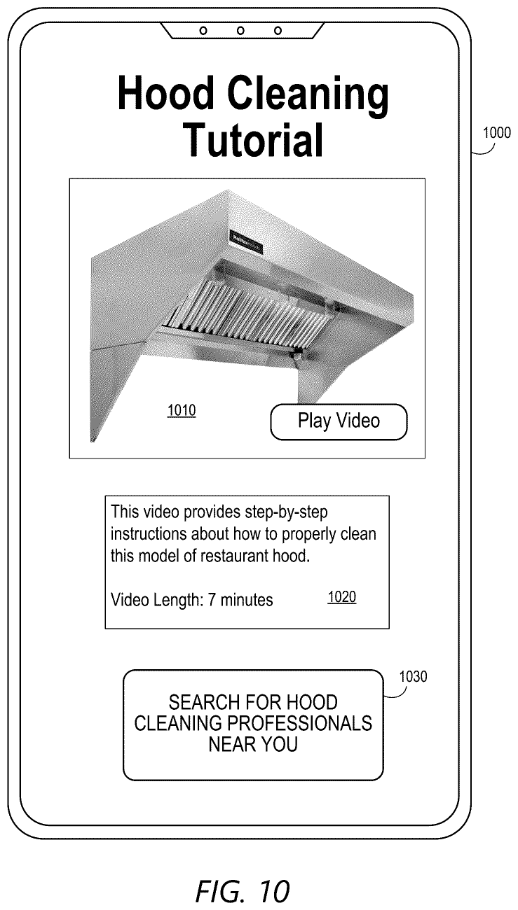

Selection of the alert 810 may result in the presentation of FIG. 9 which is a maintenance information display 900 according to some embodiments. Here, the display 900 includes more detailed information about the equipment including routine maintenance and/or cleaning recommendations 910 (e.g., as recommended by the equipment manufacturer or ML algorithm for a particular model number). Note that the display might include additional information, such as a link to an owner's manual or a link to a tutorial 920. Selection of the link to the tutorial 920 may result in is a tutorial display 1000 such as the one illustrated in FIG. 10. The display 1000 includes a video 1010 and explanation 1020 about the tutorial. Instead of cleaning the hood, the enterprise might select a “Search For Hood Cleaning Professionals Near You” icon 1030 (e.g., and receive a list of certified cleaners for a particular manufacturer or model). Other examples of tutorials might include, for example, how to prepare for a health inspection (e.g., based on local health department rules and regulations), how to maintain a clean restroom, required workplace signage (e.g., based on federal and state laws), where fire extinguishers should be located, etc.

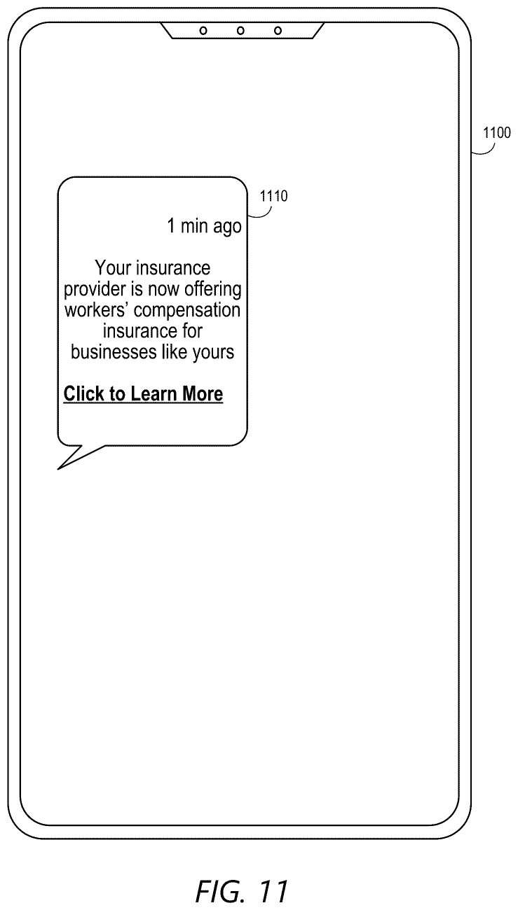

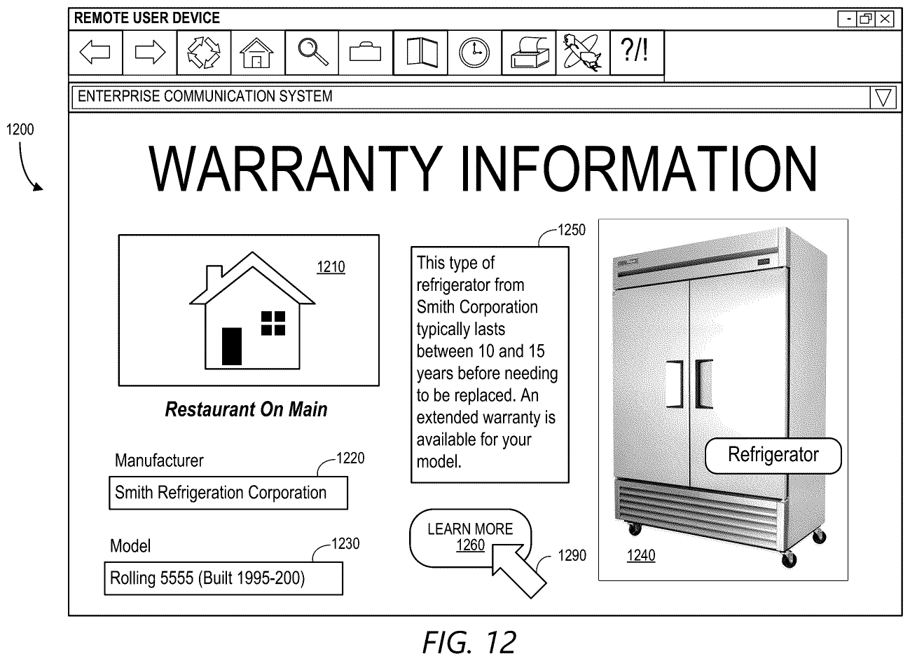

According to some embodiments, an enterprise communication system may provide additional messages to an enterprise. For example, FIG. 11 is a pop-up cross-sell notification display 1100 according to some embodiments. Here, a notification 1110 is informing the enterprise about a new type of insurance product that may be interest. Note that devices other than smartphones may be used to provide information (e.g., information associated with products or services) to an enterprise. For example, FIG. 12 is a web browser warranty information display 1200 in accordance with some embodiments. The display 1200 includes information about the enterprise (e.g., an enterprise photograph 1210) and a particular piece of enterprise equipment (e.g., a manufacturer 1220, a model 1230, an equipment photograph 1240, etc.). The display further includes one or more extended warranties 1250 or other up-sell opportunities that might be automatically recommended (e.g., based on the age of the equipment, know lifecycle issues, etc.), and a user may select a “Learn More” icon 1260 to receive additional details (e.g., via a touchscreen or computer mouse pointer 1290. According to some embodiments, the system may automatically track periods of time during which an extended warranty is available (e.g., 30 or 90 days after purchase) and remind the user about upcoming warranty deadlines.

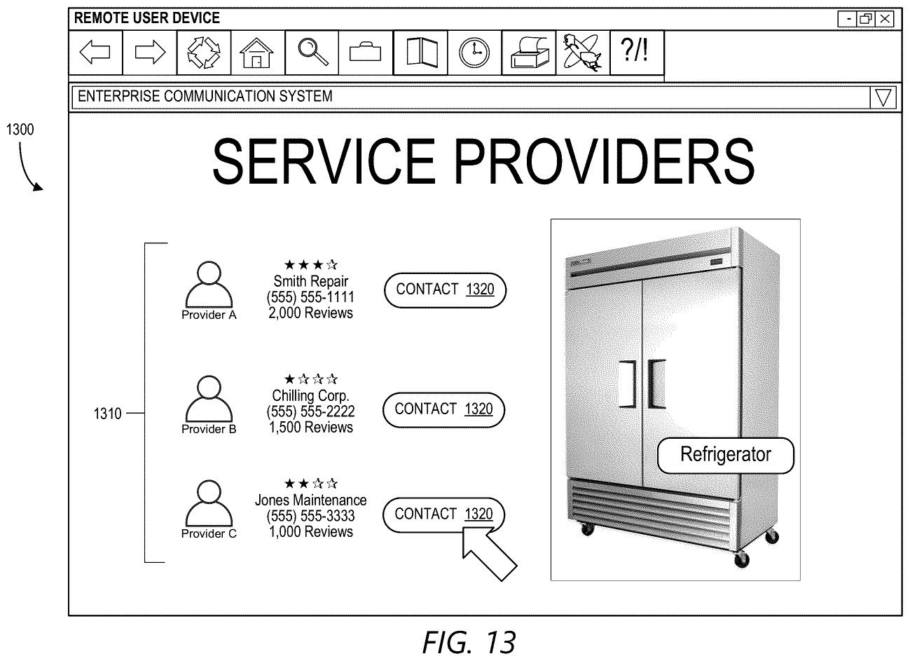

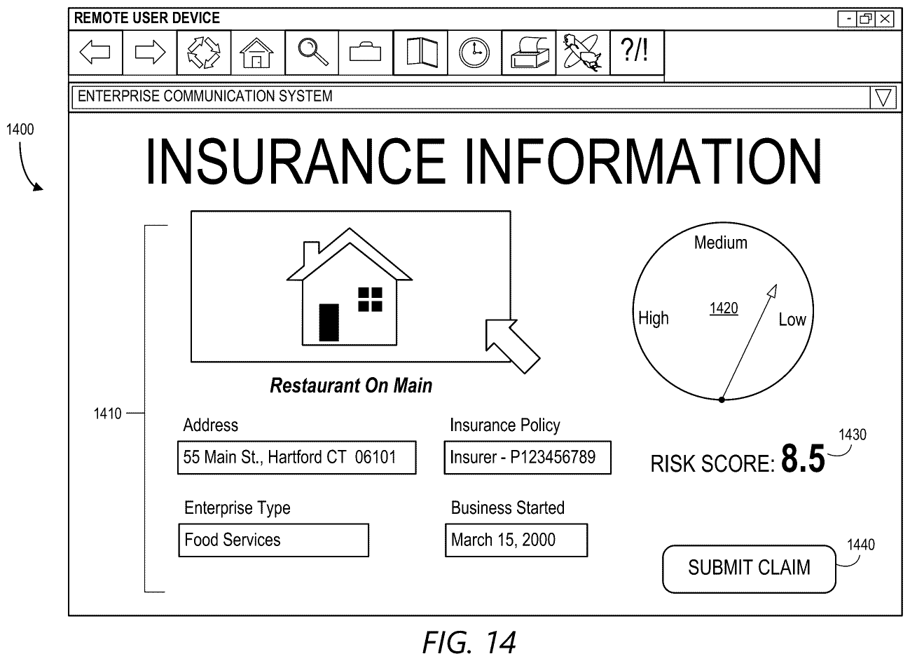

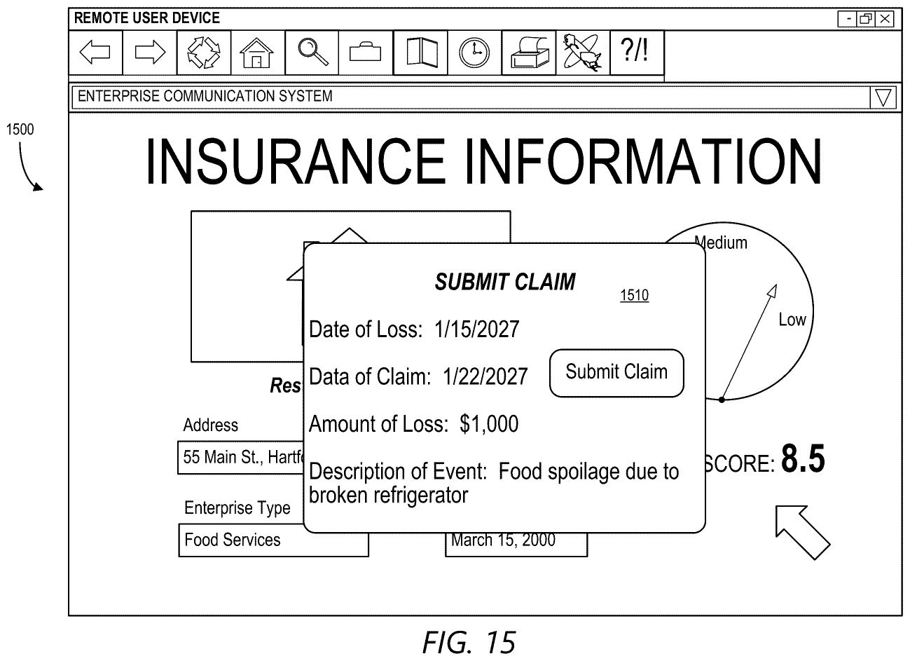

The enterprise communication system might also recommend retailers (e.g., to purchase replacement equipment) and/or service providers. For example, FIG. 13 is a service provider display 1300 according to some embodiments. Here a set of local service providers 1310 may be provided along with reviews (e.g., from social media), contact information or links 1320, etc. As another example, risk relationship information may be provided by the enterprise communication system. For example, FIG. 14 is an insurance information display 1400 in accordance with some embodiments. The display includes information about the enterprise 1410 including an insurance policy identifier and a risk score graphical 1420 and numerical 1430 presentation. According to some embodiments, selection of a “Submit Claim” icon 1440 lets a user provide insurance claim information via a display 1500 with a data entry window 1510 such as the one illustrated in FIG. 15 according to some embodiments.

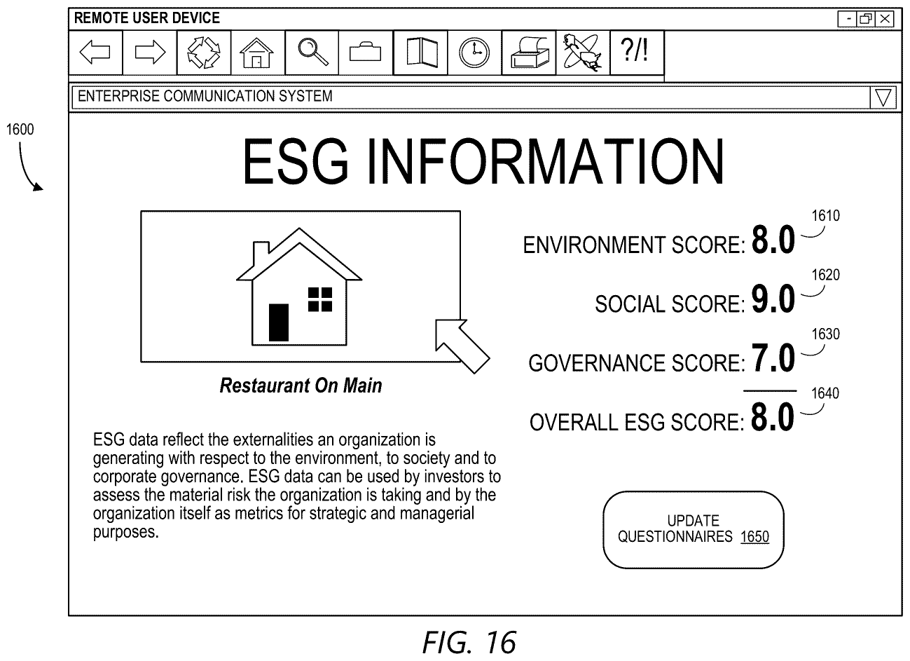

Environmental, Social, and Governance (“ESG”) scores may be associated with a set of standards for a company's behavior. FIG. 16 is an ESG information display 1600 in accordance with some embodiments. Here, an environment score 1610 may indicate how a company safeguards the environment, including, for example, corporate policies addressing climate change. A social score 1620 may be based on social criteria regarding how the company manages relationships with employees, suppliers, customers, and the communities where it operates. A governance score 1630 may reflect a company's leadership, executive pay, audits, internal controls, and shareholder rights. Based on the environment score 1610, social score 1620, and governance score 1630, an overall ESG score 1640 may be calculated. According to some embodiments some or all of these scores 1610, 1620, 1630, 1640 may be based at least in part on questionnaires completed by the enterprise (which can be updated via selection of an “Update questionnaires” icon 1650). According to some embodiments, the display 1600 may further provide suggestions to improve an overall ESG score 1640 (e.g., replacing a fryer to improve the carbon footprint of an enterprise). According to some embodiments, an ESG badge may be automatically generated when the scores 1610, 1620, 1630, 1640 (e.g., a sticker to be placed in a store window or an icon to be displayed on FACEBOOK®, YELP®, etc.

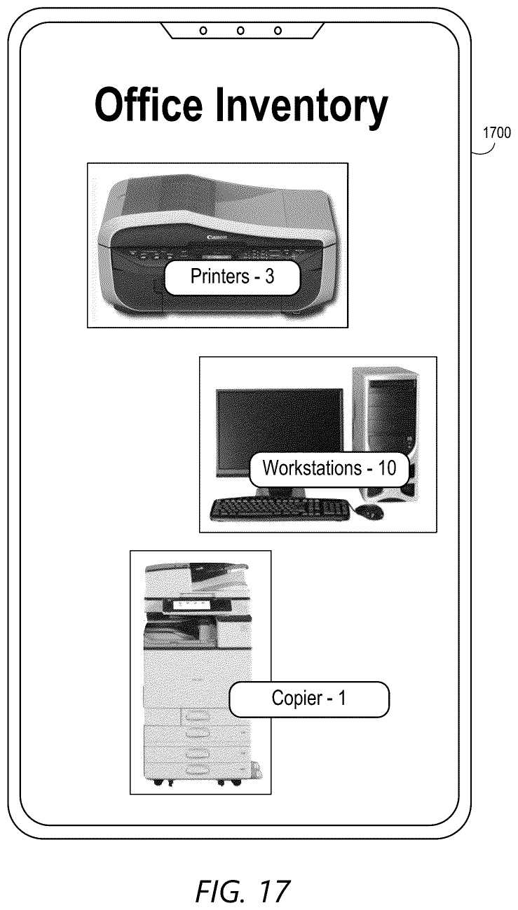

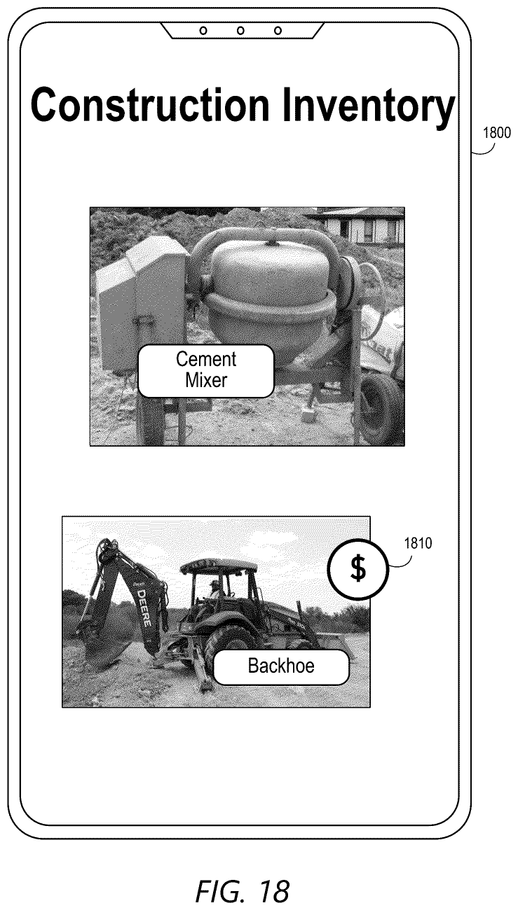

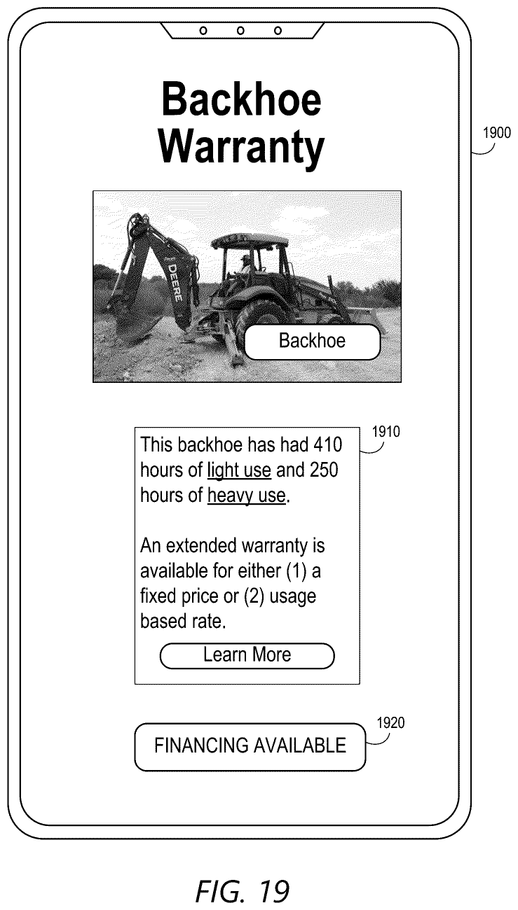

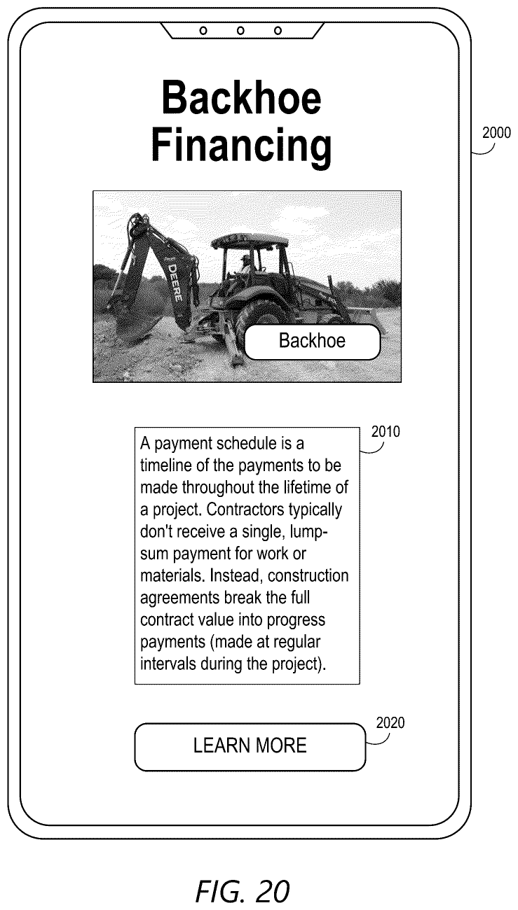

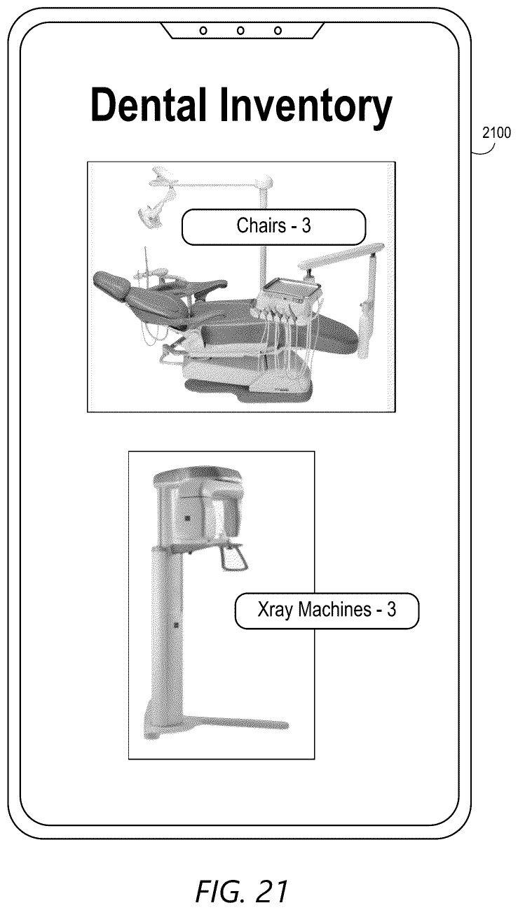

Although some embodiments have been described in connection with a food services enterprise, note that embodiments may be associated with any other type of small business. For example, FIG. 17 is an office inventory display 1700 in accordance with some embodiments. Here, the display 1700 includes various types of office equipment (e.g., printers, workstations, copiers, etc.) along with a number of units for each type. As another example, FIG. 18 is a construction inventory display 1800 according to some embodiments. Here, the display 1800 includes various types of construction equipment (e.g., cement mixers, backhoes, etc.). Note that construction equipment may be mobile in nature (e.g., moving between construction sites) and may be associated with telematics data. In some embodiments, an indication 1810 may be show when financial information about a piece of equipment is available. Selection of the indication 1810 may result, for example, in a backhoe warranty display 1900 such as the one illustrated in FIG. 19. The display 1900 includes information 1910 about equipment lifecycle and use (e.g., light use versus heavy use), extended warranty information, etc. Moreover, an indication 1920 may be shown when additional financial information is available. Selection of the indication 1920 may result in a backhoe financing display 2000 as shown in FIG. 20. This display 2000 may include cost information, such as payment schedule data for the construction equipment along with an offer to provide additional details 1920. Other types of construction equipment information might include certification management information, roadside assistance offers for construction vehicles, risk engineering services, etc. Aa still another example, FIG. 21 is dental inventory display 2100 in accordance with some embodiments. Here, the display 2100 includes various types of dental equipment (e.g., dental chairs, Xray machines, etc.) along with a number of units for each type.

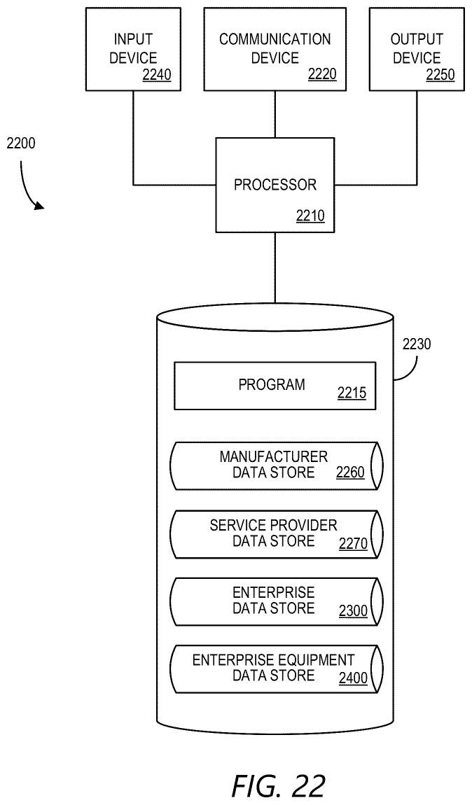

The embodiments described herein may be implemented using any number of different hardware configurations. For example, FIG. 22 illustrates an apparatus 2200 that may be, for example, associated with the system 200 described with respect to FIG. 2. The apparatus 2200 comprises a processor 2210, such as one or more commercially available Central Processing Units (“CPUs”) in the form of one-chip microprocessors, coupled to a communication device 2220 configured to communicate via a communication network (not shown in FIG. 22). The communication device 2220 may be used to communicate, for example, with one or more remote third-party business or economic platforms, administrator computers, and/or communication devices (e.g., PCs and smartphones). Note that communications exchanged via the communication device 2220 may utilize security features, such as those between a public internet user and an internal network of an insurance company and/or an enterprise. The security features might be associated with, for example, web servers, firewalls, and/or PCI infrastructure. The apparatus 2200 further includes an input device 2240 (e.g., a mouse and/or keyboard to enter information about data sources, user enterprise communication rules or preferences, third-parties, etc.) and an output device 2250 (e.g., to output reports regarding user enterprise communications, machine learning algorithms, recommendations, alerts, etc.).

The processor 2210 also communicates with a storage device 2230. The storage device 2230 may comprise any appropriate information storage device, including combinations of magnetic storage devices (e.g., a hard disk drive), optical storage devices, mobile telephones, and/or semiconductor memory devices. The storage device 2230 stores a program 2215 and/or an enterprise communication tool or application for controlling the processor 2210. The processor 2210 performs instructions of the program 2215, and thereby operates in accordance with any of the embodiments described herein. For example, the processor 2210 may access data stores to determine a selected enterprise identifier (and parameters associated with the selected enterprise identifier) and enterprise equipment parameters for the selected enterprise identifier. Based on the determined enterprise equipment parameters, processor 2210 may automatically generate at least one electronic message for the selected enterprise and transmit the electronic message in accordance with the enterprise communication link data.

The program 2215 may be stored in a compressed, uncompiled and/or encrypted format. The program 2215 may furthermore include other program elements, such as an operating system, a database management system, and/or device drivers used by the processor 2210 to interface with peripheral devices.

As used herein, information may be “received” by or “transmitted” to, for example: (i) the apparatus 2200 from another device; or (ii) a software application or module within the apparatus 2200 from another software application, module, or any other source.

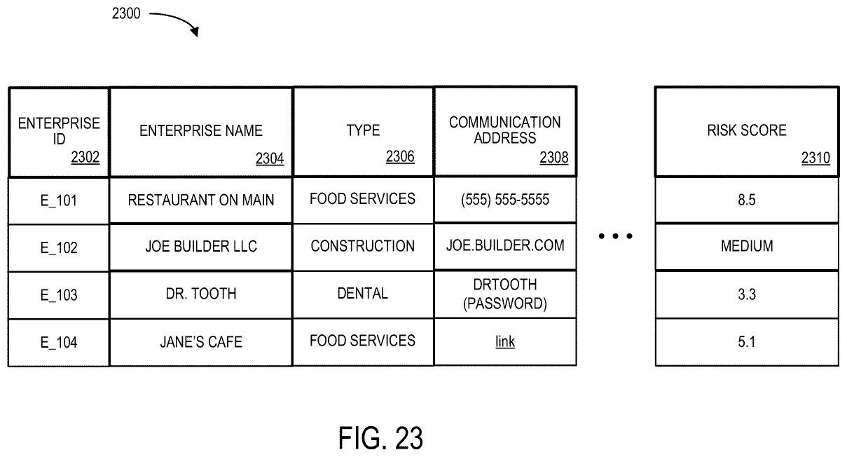

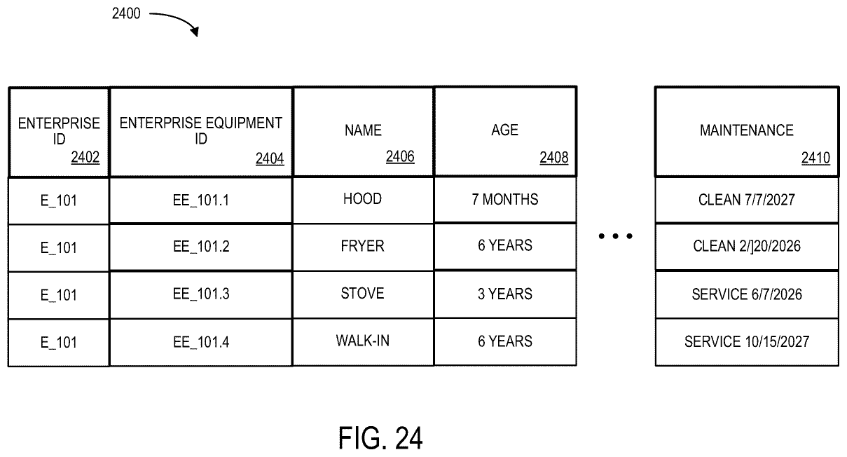

In some embodiments (such as shown in FIG. 22), the storage device 2230 further includes a manufacturer data store 2260 (e.g., including user manuals, maintenance recommendations, etc.), third-party data 2270 (e.g., with third-party user data available from public databases such as local health departments), risk relationship data (e.g., regarding insurance policies, other customers, etc.), a machine learning database, etc. The storage device 2230 may further include an enterprise data store 2300 and an enterprise equipment data store 2400. Examples of databases that might be used in connection with the apparatus 2200 will now be described in detail with respect to FIGS. 23 and 24. Note that the databases described herein are only examples, and additional and/or different information may be stored therein. Moreover, various databases might be split or combined in accordance with any of the embodiments described herein. For example, the enterprise data store 2300 and enterprise equipment data store 2400 might be combined and/or linked to each other within the program 2215.

Referring to FIG. 23, a table is shown that represents the enterprise data store 2300 that may be stored at the apparatus 2200 according to some embodiments. The table may include, for example, entries associated with businesses that utilize a communication system. The table may also define fields 2302, 2304, 2306, 2308, 2310 for each of the entries. The fields 2302, 2304, 2306, 2308, 2310 may, according to some embodiments, specify: an enterprise identifier 2302, an enterprise name 2304, a type 2306, a communication address 2308, and a risk score 2310. The enterprise data store 2300 may be created and updated, for example, based on information electrically received from various operators, administrators, and computer systems (e.g., including when a new enterprise is analyzed, or existing information is adjusted) associated with an insurer.

The enterprise identifier 2302 may be, for example, a unique alphanumeric code identifying a business that receives information from a communication system. The enterprise name 2304 and type 2306 may describe the business. The communication address 2308 may represent any information that can be used to send a message to the enterprise (e.g., a smartphone number, a username, etc.). The risk score 2310 may represent a level of risk associated with the business based (at least in part) on the equipment that the business uses.

Referring to FIG. 24, a table is shown that represents the enterprise equipment data store 2400 that may be stored at the apparatus 2200 according to some embodiments. The table may include, for example, entries associated with machines that are used by a business. The table may also define fields 2402, 2404, 2406, 2408, 2410 for each of the entries. The fields 2402, 2404, 2406, 2408, 2410 may, according to some embodiments, specify: an enterprise identifier 2402, an enterprise equipment identifier 2404, a name 2406, an age 2408, and maintenance information 2410. The enterprise equipment data store 2400 may be created and updated, for example, based on information electrically received from various operators, administrators, and computer systems (e.g., including when a new machine is added to an inventory or existing information is adjusted) associated with an insurer.

The enterprise identifier 2402 may be, for example, a unique alphanumeric code identifying a business that receives information from a communication system. The enterprise equipment identifier 2404 and name 2406 may describe a machine that is used by the business in day-to-day operation. The age 2408 may represent when the machine began operation and may be used to help determine the maintenance information 2410 (e.g., indicating when the machine should be cleaned or otherwise serviced).

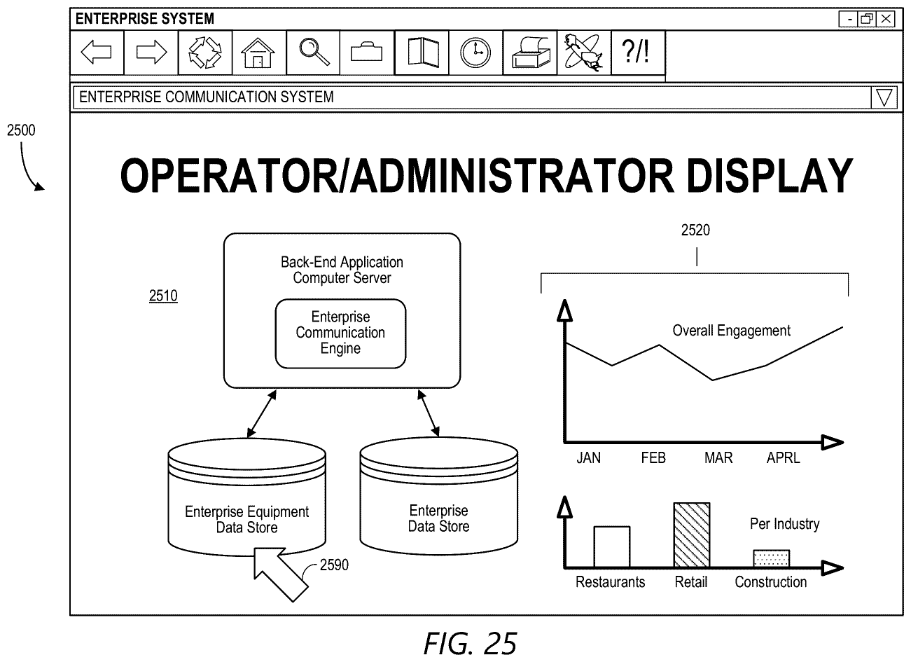

The operation of the enterprise communication system may be controlled via a Graphical User Interface (“GUI”). For example, FIG. 25 is an enterprise communication operator or administrator display 2500 including graphical representations of elements of a communication system 2510 according to some embodiments. Selection of a portion or element of the display 2500 via a pointer 2590 might result in the presentation of additional information about that portion or element (e.g., a popup window presenting a data source or result table) or let an operator or administrator enter or annotate additional information about resource allocations (e.g., based on his or her experience and expertise). As shown in FIG. 25, dashboard information 2520 may also be provided on the display 2500. The dashboard information 2520 might reflect, for example, how engaged users are when interacting with the system, how often cross-sell or up-sell offers are being accept in various industries or geographic locations, etc.

Thus, embodiments may provide an automated and efficient way to communicate information to enterprises.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of enterprises, embodiments may instead be associated with other types of small businesses in additional to and/or instead of those described herein (e.g., including property owners with janitorial staff, medical providers, retailers, wholesalers, importers, craftspeople, manufacturing plants, etc.). Similarly, although certain types of insurance and enterprise parameters were described in connection some embodiments herein, other types of insurance products and/or enterprise parameters might be used instead.

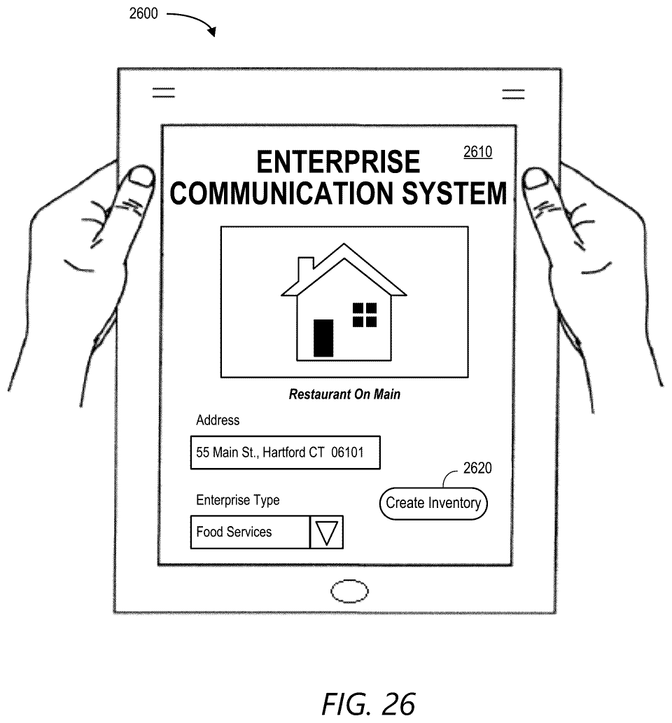

Note that the displays and devices illustrated herein are only provided as examples, and embodiments may be associated with any other types of user interfaces. For example, FIG. 26 illustrates a tablet computer 2600 with an enterprise communication display 2610 according to some embodiments. The enterprise communication display 2610 shows elements that may be utilized by a user of the handheld computer 2600 (e.g., via an “Create Inventory” icon 2620) to provide additional equipment (or to delete equipment that is no longer used). Other embodiments might utilize customized two-way voice interaction workflows with an enterprise (e.g., via a smart home speaker such as the ECHO® smart home speaker and associated ALEXA® interface available from AMAZON®).

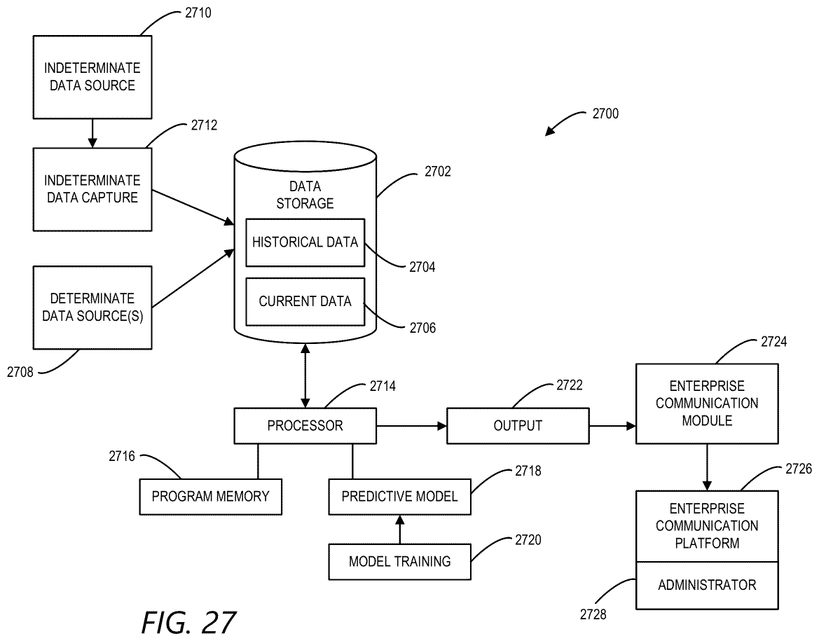

According to some embodiments, one or more predictive models may be used to customize workflows for a user (e.g., to generate maintenance recommendations or select offers). Features of some embodiments associated with a predictive model will now be described by referring to FIG. 27. FIG. 27 is a partially functional block diagram that illustrates aspects of a computer system 2700 provided in accordance with some embodiments of the invention. For present purposes it will be assumed that the computer system 2700 is operated by an insurance company (not separately shown) for the purpose of supporting automated enterprise communications (e.g., to streamline the collection of inventory information from a user). According to some embodiments, the third-party data and/or risk relationship data may also be used to supplement and leverage the computer system 2700.

The computer system 2700 includes a data storage module 2702. In terms of its hardware the data storage module 2702 may be conventional, and may be composed, for example, by one or more magnetic hard disk drives. A function performed by the data storage module 2702 in the computer system 2700 is to receive, store and provide access to both historical transaction data 2704 and current transaction data 2706. As described in more detail below, the historical transaction data 2704 is employed to train a predictive model to provide an output that indicates an identified performance metric and/or an algorithm to score or evaluate maintenance decisions, and the current transaction data 2706 is thereafter analyzed by the predictive model. Moreover, as time goes by, and results become known from processing current transactions, at least some of the current transactions may be used to perform further training of the predictive model. Consequently, the predictive model may thereby adapt itself to changing conditions.

Either the historical transaction data 2704 or the current transaction data 2706 might include, according to some embodiments, determinate and indeterminate data. As used herein and in the appended claims, “determinate data” refers to verifiable facts such as an age of a device; a device type; a policy date or other date; a time of day; a day of the week; a geographic location, address or ZIP code; and a policy number.

As used herein, “indeterminate data” refers to data or other information that is not in a predetermined format and/or location in a data record or data form. Examples of indeterminate data include narrative speech or text, information in descriptive notes fields and signal characteristics in audible voice data files, real-time detection of user reactions and mood (is the user bored or annoyed?).

The determinate data may come from one or more determinate data sources 2708 that are included in the computer system 2700 and are coupled to the data storage module 2702. The determinate data may include “hard” data like an enterprise name, date of incorporation, tax identifier number, insurance policy number, address, an underwriter decision, etc. One possible source of the determinate data may be the insurance company's policy database (not separately indicated).

The indeterminate data may originate from one or more indeterminate data sources 2710 and may be extracted from raw files or the like by one or more indeterminate data capture modules 2712. Both the indeterminate data source(s) 2710 and the indeterminate data capture module(s) 2712 may be included in the computer system 2700 and coupled directly or indirectly to the data storage module 2702. Examples of the indeterminate data source(s) 2710 may include data storage facilities for document images, for text files, and digitized recorded voice files. Examples of the indeterminate data capture module(s) 2712 may include one or more optical character readers, a speech recognition device (i.e., speech-to-text conversion), a computer or computers programmed to perform natural language processing, a computer or computers programmed to identify and extract information from narrative text files, a computer or computers programmed to detect key words in text files, and a computer or computers programmed to detect indeterminate data regarding an enterprise or device such as a health inspection report, a repair bill, etc.

The computer system 2700 also may include a computer processor 2714. The computer processor 2714 may include one or more conventional microprocessors and may operate to execute programmed instructions to provide functionality as described herein. Among other functions, the computer processor 2714 may store and retrieve historical insurance transaction data 2704 and current transaction data 2706 in and from the data storage module 2702. Thus, the computer processor 2714 may be coupled to the data storage module 2702.

The computer system 2700 may further include a program memory 2716 that is coupled to the computer processor 2714. The program memory 2716 may include one or more fixed storage devices, such as one or more hard disk drives, and one or more volatile storage devices, such as RAM devices. The program memory 2716 may be at least partially integrated with the data storage module 2702. The program memory 2716 may store one or more application programs, an operating system, device drivers, etc., all of which may contain program instruction steps for execution by the computer processor 2714.

The computer system 2700 further includes a predictive model component 2718. In certain practical embodiments of the computer system 2700, the predictive model component 2718 may effectively be implemented via the computer processor 2714, one or more application programs stored in the program memory 2716, and computer stored as a result of training operations based on the historical transaction data 2704 (and possibly also data received from a third party). In some embodiments, data arising from model training may be stored in the data storage module 2702, or in a separate computer store (not separately shown). A function of the predictive model component 2718 may be to determine appropriate performance metric scores, scoring algorithms, communication messages, etc. The predictive model component may be directly or indirectly coupled to the data storage module 2702.

The predictive model component 2718 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein.

Still further, the computer system 2700 includes a model training component 2720. The model training component 2720 may be coupled to the computer processor 2714 (directly or indirectly) and may have the function of training the predictive model component 2718 based on the historical transaction data 2704 and/or information about users and user interactions. (As will be understood from previous discussion, the model training component 2720 may further train the predictive model component 2718 as further relevant data becomes available.) The model training component 2720 may be embodied at least in part by the computer processor 2714 and one or more application programs stored in the program memory 2716. Thus, the training of the predictive model component 2718 by the model training component 2720 may occur in accordance with program instructions stored in the program memory 2716 and executed by the computer processor 2714.

In addition, the computer system 2700 may include an output device 2722. The output device 2722 may be coupled to the computer processor 2714. A function of the output device 2722 may be to provide an output that is indicative of (as determined by the trained predictive model component 2718) particular performance metrics and/or communication messages. The output may be generated by the computer processor 2714 in accordance with program instructions stored in the program memory 2716 and executed by the computer processor 2714. More specifically, the output may be generated by the computer processor 2714 in response to applying the data for the current simulation to the trained predictive model component 2718. The output may, for example, be a numerical estimate, a likelihood within a predetermined range of numbers, a defined series of communication message, a defined series of questions, etc. In some embodiments, the output device may be implemented by a suitable program or program module executed by the computer processor 2714 in response to operation of the predictive model component 2718.

Still further, the computer system 2700 may include an enterprise communication module 2724. The enterprise communication module 2724 may be implemented in some embodiments by a software module executed by the computer processor 2714. The enterprise communication module 2724 may have the function of rendering a portion of the display on the output device 2722. Thus, the enterprise communication module 2724 may be coupled, at least functionally, to the output device 2722. In some embodiments, for example, the enterprise communication module 2724 may direct communications with an enterprise by referring to an administrator 2728 via an enterprise communication platform 2726, messages customized and/or generated by the predictive model component 2718 and found to be associated with various enterprises or types of enterprises. In some embodiments, these results may be provided to an administrator 2728 who may also be tasked with determining whether or not the messages may be improved.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. An enterprise communication system implemented via a back-end application computer server, comprising:
(a) an enterprise data store that contains electronic records associated with a plurality of enterprises, and, for each enterprise, a set of electronic records including an enterprise identifier, enterprise communication link data, and parameters associated with that enterprise;
(b) an enterprise equipment data store that contains electronic records associated with the plurality of enterprises, and, for each enterprise, a set of electronic records including an enterprise identifier, a set of enterprise equipment identifiers, and equipment parameters associated with each enterprise equipment identifier;
(c) the back-end application computer server, coupled to the enterprise data store and enterprise equipment data store, to:
access the enterprise data store to determine a selected enterprise identifier and parameters associated with the selected enterprise identifier,
access the enterprise equipment data store to determine enterprise equipment parameters associated with the selected enterprise identifier,
based on the determined enterprise equipment parameters, automatically generate at least one electronic message for the selected enterprise, and
automatically transmit the electronic message in accordance with the enterprise communication link data; and
(d) a communication port coupled to the back-end application computer server to facilitate an exchange of data with a remote enterprise device to support interactive user interface displays that collect information, including equipment parameters, to be stored in the enterprise equipment data store.

2. The system of claim 1, wherein the parameters associated with the enterprise include at least one of: (i) an enterprise name, (ii) an enterprise address, (iii) an enterprise date, and (iv) a risk relationship identifier.

3. The system of claim 1, wherein the enterprise communication link data includes at least one of: (i) a communication address, (ii) a telephone number, (iii) an email address, and (iv) a username and password.

4. The system of claim 1, wherein the parameters associated with the enterprise include an enterprise type.

5. The system of claim 4, wherein the collection of information about the enterprise equipment is based at least in part on the enterprise type.

6. The system of claim 5, wherein the enterprise equipment parameters include at least one of: (i) an equipment type, (ii) a manufacturer, (iii) a model number, (iv) a date of manufacture, and (v) Internet of Things (“IoT”) information.

7. The system of claim 1, wherein the electronic message is associated with equipment maintenance information.

8. The system of claim 1, wherein the electronic message is associated with a tutorial.

9. The system of claim 1, wherein the electronic message is associated with cross-sell information.

10. The system of claim 1, wherein the electronic message is associated with a push notification.

11. The system of claim 1, wherein the electronic message is associated with enterprise insights.

12. The system of claim 1, wherein the electronic message is associated with equipment lifecycle information.

13. The system of claim 1, wherein the electronic message is associated with at least one of: (i) a product warranty, and (ii) equipment financing.

14. The system of claim 1, wherein the electronic message is associated with at least one of: (i) an equipment maintenance service provider, and (ii) an equipment retailer.

15. The system of claim 1, wherein the back-end application computer server is further to calculate an enterprise risk score based at least in part on the enterprise equipment parameters associated with the selected enterprise identifier.

16. The system of claim 1, wherein the back-end application computer server is associated with an insurer.

17. The system of claim 16, wherein the back-end application computer server is further to facilitate processing of an insurance claim.

18. The system of claim 1, wherein the back-end application computer server is further to calculate an enterprise environmental, social, and corporate governance score based at least in part on the enterprise equipment parameters associated with the selected enterprise identifier.

19. An enterprise communication method implemented via a back-end application computer server, comprising:
accessing, by the back-end application computer server, an enterprise data store to determine a selected enterprise identifier and parameters associated with a selected enterprise identifier, wherein the enterprise data store contains electronic records associated with a plurality of enterprises, and, for each enterprise, a set of electronic records including an enterprise identifier, enterprise communication link data, and parameters associated with that enterprise;
accessing an enterprise equipment data store to determine enterprise equipment parameters associated with the selected enterprise identifier, wherein the enterprise equipment data store contains electronic records associated with the plurality of enterprises, and, for each enterprise, a set of electronic records including an enterprise identifier, a set of enterprise equipment identifiers, and equipment parameters associated with each enterprise equipment identifier;
based on the determined enterprise equipment parameters, automatically generating at least one electronic message for the selected enterprise; and
automatically transmitting the electronic message in accordance with the enterprise communication link data.

20. A non-transitory, computer-readable medium storing instructions, that, when executed by a processor, cause the processor to perform an enterprise communication method implemented via a back-end application computer server, the method comprising:
accessing, by the back-end application computer server, an enterprise data store to determine a selected enterprise identifier and parameters associated with a selected enterprise identifier, wherein the enterprise data store contains electronic records associated with a plurality of enterprises, and, for each enterprise, a set of electronic records including an enterprise identifier, enterprise communication link data, and parameters associated with that enterprise;
accessing an enterprise equipment data store to determine enterprise equipment parameters associated with the selected enterprise identifier, wherein the enterprise equipment data store contains electronic records associated with the plurality of enterprises, and, for each enterprise, a set of electronic records including an enterprise identifier, a set of enterprise equipment identifiers, and equipment parameters associated with each enterprise equipment identifier;
based on the determined enterprise equipment parameters, automatically generating at least one electronic message for the selected enterprise; and
automatically transmitting the electronic message in accordance with the enterprise communication link data.
